(19) United States
(12) Patent Application Publication
(10) Pub. No.: US 2004/0083143 A1
(43) Pub. Date: Apr. 29, 2004

(54) System for enabling internet shopping experience

(76) Inventor: Roslyn Rodger, Rockhampton (AU)

Correspondence Address: WILLIAM COLLARD, COLLARD & ROE, P.C., 1077 NORTHERN BOULEVARD, ROSLYN, NY, 11576, US

(21) Appl. No.: 10/469,675

(22) PCT Filed: Mar. 4, 2002
(86) PCT No.: PCT/AU02/00238

(30) Foreign Application Priority Data
Mar. 2, 2001 (AU) PR 3491

(51) Int. Cl. G06F 17/60

(52) U.S. Cl. 705/27

(57) ABSTRACT

A system and method for enabling a shopping experience at a shopping center over the Internet including, a shopping center subscription based portal subscribed to by individual shop owners of a shopping center, the portal providing access to the websites of the subscribing shop owners, the portal contactable through a URL by users, via a user system; a directory component adapted to enable location of a particular shopping center, shop name, floor level of the shopping center or type of goods or services; a navigation component adapted to display an assimilated ambulatory walk-through of the shopping center; a transactional component adapted to enable purchases to be made online; an information component adapted to provide shoppers with advertising information and general information, and a database for the storage and retrieval of data and information, wherein in operation the shopper can, experience shopping at the shopping center by being able to navigate through the shopping center and make purchases as if physically present in the shopping center.

### FIELD OF THE INVENTION

This invention relates to Internet commerce in particular but not limited to a system for providing a virtual and ambulatory shopping experience at a shopping center or mall via the Internet.

### BACKGROUND OF THE INVENTION

Transactional Internet e-commerce is well known prior art. Large organisations are able to use the Internet to fund, develop and market their own online shopping sites thereby enabling their capture of the majority of online marketing opportunities. Examples of such sites include d-store.com, e-store.com.au, sold.com.au and of course, the well known, amazon.com.

Small or medium size businesses are disadvantaged where the wholesaling and retailing of a large variety of products is sourced by the large organisafions and on-sold to consumers. This is because small to medium size businesses usually do is not have the resources or knowledge to compete on a similar scale in capturing this highly lucrative online market

Online e-commerce although simple in concept and practice, has minimised social interaction which is a vital aspect of the experience of physically shopping at a shopping center or mall. The experience of the shopping center environment, atmosphere, personal customer service and the ability to pay by various means is absent from the systems of purchasing goods and services online. Furthermore, due to the rapid advancement of e-commerce, there are important considerations such as whether or not small to medium size businesses will survive, and the effect of their demise with respect to employment, business and society in general with particular emphasis on the social economic changes in regional and metropolitan areas.

Another aspect of the online shopping trend is the creation of the portal/information-based site acting as a referral directory to individual businesses' sites, for example, ninemsn.com.au, looksmart.com, excite.com.au. For a business/organisation to be involved with this style of online shopping, it has to pay to be linked and essentially needs its own online shopping website. The creation of individual websites is expensive which only advantages those businesses that can afford them. To effectively utilise this style of online shopping, consumers have to adapt to each individual trader site's navigational style. The variation in navigational styles often confuses consumers by not providing them with consistency and ease to purchase online.

As a result, this style of online shopping is likely to lose consumers for two main reasons—firstly, due to inconsistencies between the websites; and secondly, is the belief that small to medium size businesses are disadvantaged due to high costs of constructing and maintaining their online store is perpetuated, therefore making them unable to compete in this marketplace.

Due to the initial hype of a boom in e-commerce, leading retailers have been encouraged to construct individual online “stores” in anticipation of future downturn effects on bricks and mortar shopping. The traditional bricks and mortar concept has encouraged small to medium size businesses to physically occupy adjacent space to benefit from the high traffic flow of major retailers. With the introduction of online shopping, this traditional practice of retailing has been undermined. Large retailers have developed individual online “stores” and are actively encouraging consumers to purchase online, as opposed to entering their actual premises. The result of this style of marketing is to take away the traffic flow of consumers to neighbouring and usually, smaller businesses. This is of course one of the main ways that small to medium size businesses attract their clientele.

Furthermore, there are many aspects of online shopping that disadvantage the consumer inclusive of which are the completion of a potential sale, such as touch and feel, interaction with a sales person and the visual presence of bricks and mortar shopping which has been positively shown to encourage impulse buying.

If the present style of online shopping continues, small to medium size businesses which already suffer due to a lack of traffic flow will inevitably not survive. Consumers will be left with little option other than to deal with the larger retailers because of their ability to provide both online retailing and the advantages of bricks and mortar shopping.

The current technology of online shopping has failed to enhance the traditional benefits of bricks and mortar shopping to smaller retailers. As a result there is essentially little to no opportunity for small to medium size businesses to compete and survive without developing their own online shopping strategies.

### OBJECT OF THE INVENTION

It is therefore an object of the present invention to seek to alleviate some of the disadvantages and limitations of the prior art or to at least provide the public with a useful choice.

### STATEMENT OF THE INVENTION

According to one aspect, the invention resides in a system for enabling a shopping experience at a shopping center over the Internet including in combination, A web server hosting a shopping center subscription based portal website subscribed to by individual shop owners of a shopping center, the portal website providing access to the websites of the subscribing shop owners, the portal website contactable through a universal resource locator by users, typically customers or shoppers, via a user system; the web server interfacing with

a directory component adapted to enable location of a particular shopping center, shop name, floor level of the shopping center or type of goods or services, product, trade mark or by use of other key words;

a navigation component adapted to display an ambulatory walk-through of the shopping center, shop or floor level;

a transactional component adapted to enable purchases to be made online, through a central merchant facility or directly from a particular merchant;

an information component adapted to provide shoppers with advertising information and general information about the shopping center; and

a database for the storage and retrieval of data and information necessary for the operation of the transactional component and the information component, wherein in operation the shopper can, on logging on the website and following instructions provided, experience shopping at the shopping center by being able to navigate through the shopping center and make purchases as if physically present in the shopping center.

Preferably the user system is a computer system with interactive display means for communication via the Internet.

Preferably the interactive display means includes a visual display unit with an interactive device, typically a keypad, touch pad, mouse and/or joystick device.

Preferably the directory component enables shopping centers or merchants subscribing to the service provider's website to be located by their title, name, physical address, locality or postcode designation.

Preferably the navigation component provides a display of a walk-through from the shopping center car parks, lifts, escalators, walkways and other public utilities present in a shopping center wherein the shopper is provided with an ambulatory shopping experience as if present physically at the shopping center.

Preferably the transactional services component also includes an online bidding component adapted to enable the shopper to submit bids for goods or services to one or more selected merchants of to merchants at large and for the merchant or merchants to accept the bid online.

Preferably, the bidding component includes an interactive facility wherein real time negotiations can be conducted between the shopper and the merchant or merchants.

Preferably the information component also provides short video clippage of merchants discussing their goods and/or services and can provide real time online communication between the shopper and the merchant if desired.

Preferably the service provider provides a delivery service of goods purchased through the system.

In another aspect, the invention resides in a method of shopping utilizing the system for enabling a shopping experience at a shopping center over the Internet substantially as herein described and claimed including the steps of:

1. logging on to the subscription based portal website via the user system;

2. by following displayed instructions, selecting via the directing component, a shopping cente, shop name, type of goods or services or other key word;

3. navigating via the navigation component through the particular shopping center selected by the simulated ambulatory walk through to a particular shop; and

4. ordering or purchasing goods or services facilitated via the transactional component.

In another aspect, the invention resides in a method of shopping utilizing the system for enabling a shopping experience at a shopping center over the Internet substantially as herein described with reference to the accompanying diagrams.

### BRIEF DESCRIPTION OF THE DRAWINGS

In order that the invention be more readily understood and put into practical effect, reference will now be made to the accompanying illustrations wherein:

FIGS. 1a to 1d comprises a flow diagram of a preferred embodiment of the invention in operation according to Example 1.

### DETAILED DESCRIPTION OF THE DRAWINGS

### EXAMPLE 1

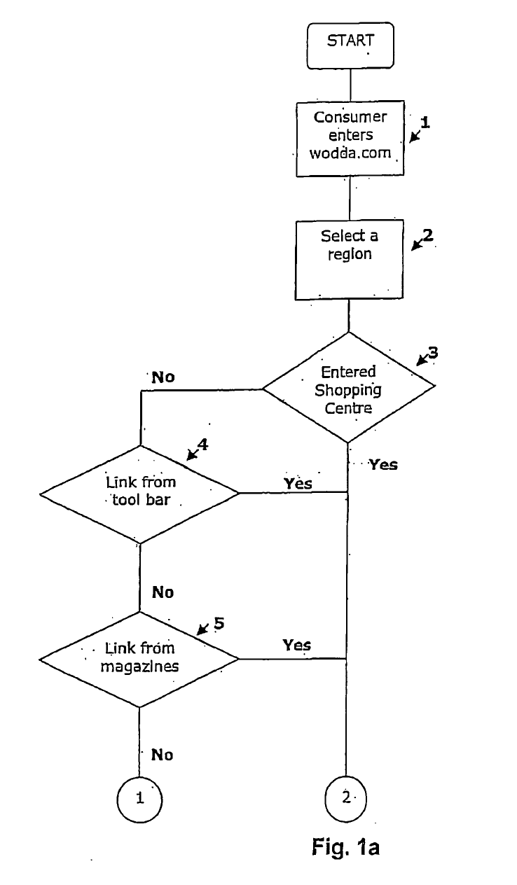

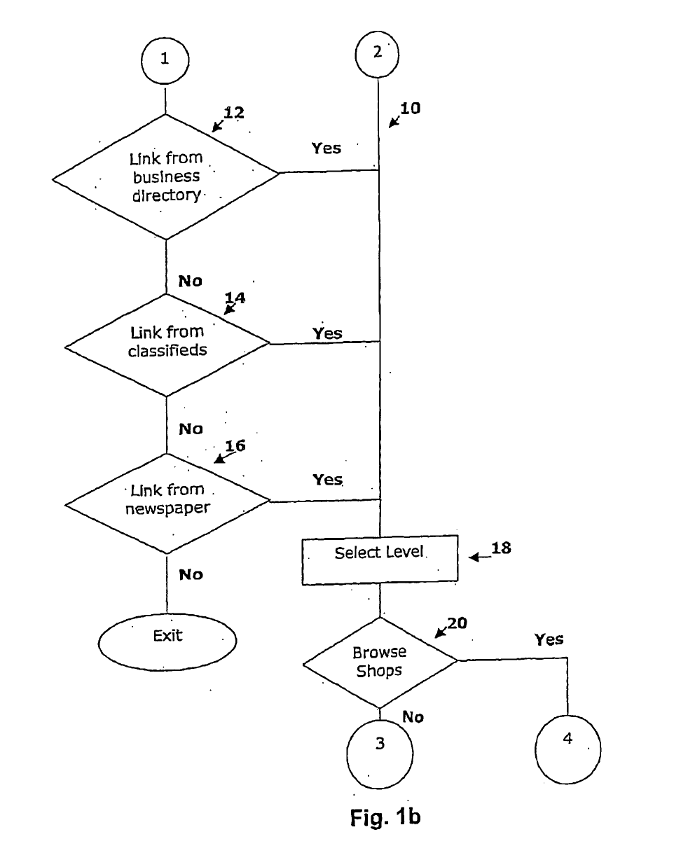

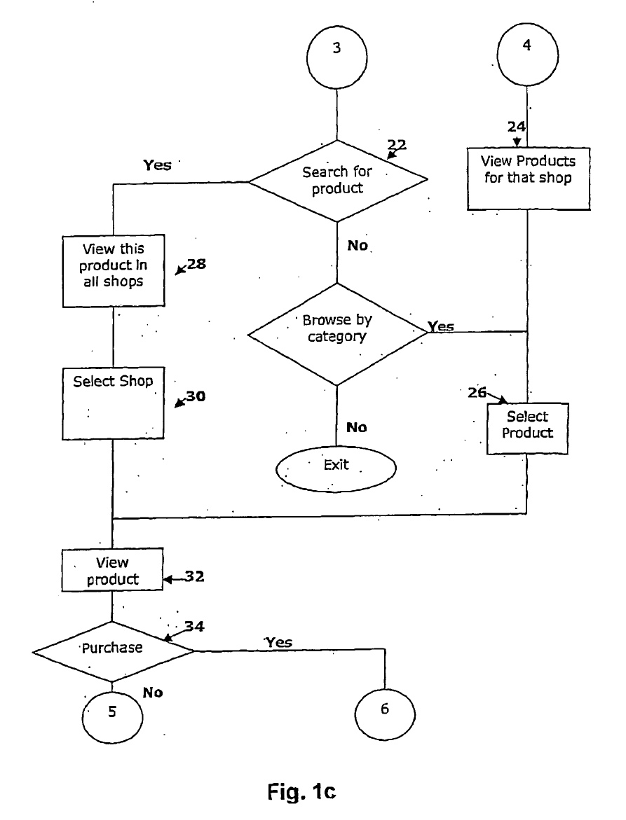

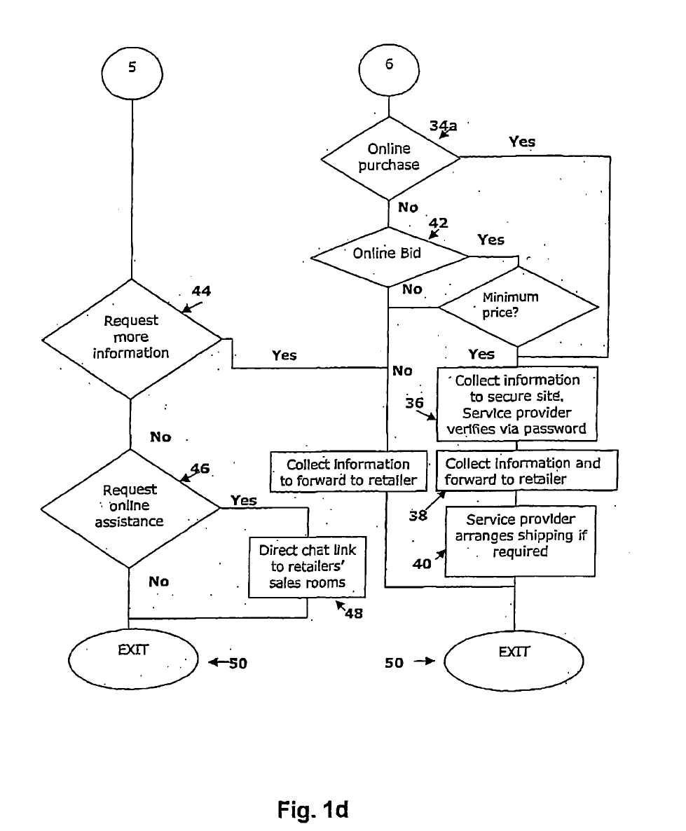

Referring now to FIGS. 1a to 1d, there is shown a flow diagram of the preferred embodiment of the invention in operation according to Example 1. The diagrams are arranged on consecutive pages so that the bottom of FIG. 1a flows on to the top of FIG. 1b, the bottom of FIG. 1b to the top of FIG. 1c, and so on. Users or potential customers are provided Internet access to the shopping center host portal provider website via a universal resource locator (URL), for example www.wodda.com 1. The host portal website provides access to individual websites by subscribing shop owners in a particular shopping center on a subscription or joining fee basis. Such web linkages can be organised by means of proprietary software available to web designers and Internet service providers or can be specifically written in house. Proprietary software packages presently available to perform some but not all of the tasks necessary for the system of the invention include

Microsoft Internet Information Server® which is a Web Server program that enables the delivery and generation of static and dynamic WebPages;

Microsoft Access® which is a database program that enables the quick storage and retrieval of information. In the near future, the database will be converted from Microsoft Access® to SQL for ease and speed of use;

The languages used on the present system include as follows:

Microsoft Visual Basic® which is an object orientated programming language used for application to Microsoft Windows®;

VBScript which is a subset to the Visual Basic Language;

Microsoft Active Server Pages® which is an application environment in which HTML, scripts, and reusable Active X® server components are combined to create dynamic Web Pages. Active Server Pages enable server side scripting for the Microsoft Internet Information Server;

Microsoft SQL Server™ is a database program that enables the quick storage and retrieval of information;

Active X® programs will be developed using the Visual Basic language to provide interface for monitoring financial transactions.

As can be seen from the above programs, such as Microsoft Internet Information Server are available to all web developers as a part of Microsoft's NT4 Server Package.

To create the database and all the necessary interfaces as well as the active pages, requires specialised programming to meet the requirements of the tasks.

Users of the subscription based shopping center portal website 1 log on to the site via the Internet. By following commands displayed on the user systems, the user selects from a list of geographical regions 2, the shopping center the user intends to “visit”. In addition, users can also be directed to the portal website from a number of links such as from the toolbar 4, from a magazine 5, or from a business directory link 12, a classified advertisement link 14, a newspaper link 16 or via results from searches or from other shopping websites. The user could also be directed to the service provider's website from a universal resource locator provided in a magazine article 5 or other publication. By following interactive commands displayed on the user system, the user selects a particular shopping center or locality the user intends to “visit” from the directory component 3. The user then “enters” a shopping centre 3 and selects a floor level 18 of the shopping center via the navigation component wherein they can browse 20 and select a particular shop.

The user can also select 26 for a product for example a Sony™ DVD player via the directory component and can obtain a list of shops that sell that product 28. The user can then select 30 the particular shop and view 32 product via the information component. Preferably the directory component contains sub-catagories wherein the user can browse and select other products and view those items from various shops.

If the user decides to purchase 34 a product online 34a, information about the user can be collected via the transactional component wherein a user password can be checked and credit card details verified. Once the details of the user are verified, the order is forwarded 38 to the retailer. If the user wishes to pay by cheque or cash, the appropriate details are forwarded directly to the retailer shop. On advice from the retailer that the product is available and that the cash or cheque payment has been received, the service provider can make arrangements to ship the product directly to the purchaser 40. If the user wishes to make a bid 42 on the particular item which is similar to bartering with a retailer the user can give the retailer the opportunity to match a price, the retailer can fix a minimum price on all items and an auto-responder will accept or reject an offer automatically. If the retailer does not have an Internet connection, this information can be faxed by a fax server to the retailer. If the user does not wish to purchase the product or would like more information, the user can request 44 more information on the product via the information component. Such a request for information will be forwarded to the retailer for them to respond accordingly. The user can request online assistance 46 from those retailers appropriately equipped. This can be achieved via online chat rooms 48 provided by the service provider or via online video conferencing through a server provided by the service provider. On completion of the transaction, the user exits 50 to the point at which they entered the shopping center or can select another floor or perform another search.

### Advantages

The advantages of the present invention include:

The service provider provides a universal platform for e-commerce

The service provider does not source or sell its own products.

It provides technical expertise to structure the shopping center and maintain the site with current technology.

It markets and promotes the service provided to create and maintain traffic flow.

It allows retailers to provide consumers with consistency of navigation.

It provides retailers with the added facility of capturing the online market, encouraging consumers to enter the bricks and mortar store if not wanting to purchase online.

It allows a local business to offer its products/services to a local online audience as well as world wide.

The service provider provides the facility for a business to sell its products online without the need of its own website, email address or even an Internet connection.

Businesses do not have to pay a commission to the service provider on sales transactions.

Businesses still have the opportunity to brand name their businesses.

The service provider provides the option for the retailer to choose a level of exposure that suits its position, which is equivalent to the bricks and mortar model.

The business does not have to be concerned with delivery arrangements as the service provider will provide this service.

The service provider provides the opportunity for all businesses to compete is online within a centralised shopping center thereby replicating the model of bricks and mortar.

Small to medium size businesses will have the advantage of the high traffic flow that leading retailers attract, again replicating the model of bricks and mortar.

Consumers will have the opportunity to purchase/browse a large variety of products from small or medium size businesses through to large organisations under the same “roof”.

Uniform Navigation-ensures consumers do not have to adjust to various online stores' different styles of navigational designs.

An environment and atmosphere replicating that of bricks and mortar allows for the transition of traditional purchasing to an online model.

Consumers have the opportunity to pre-shop and browse online, enabling them to enter the bricks and mortar store and make a traditional purchase it need be.

Consumers have a greater selection of products from various retailers.

Consumers have the choice to buy online from local businesses thereby supporting their local economy.

In conclusion, the Internet has allowed consumers and retailers to sell and purchase on a global market. The service provider utilises the technology of the Internet to reflect the way we live-we live locally, buy locally, therefore the service provider allows local retailers to sell their products and services to either local or worldwide consumers. The fundamentals of shopping will not change because of the Internet.

The opportunity to buy outside our local region has always been available through mail order, catalogue, phone order, telemarketing and now over the Internet. These channels of purchasing do not allow the consumer to interact with the sales is person on a one-to-one basis, or give them the ability to access the retailer in our local region, or let them touch and feel the product. These are all fundamental attributes of shopping. The concept of the service provider of the present invention incorporates these fundamental attributes and encourages the consumer to purchase online or enter the bricks and mortar store.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1. A system for enabling a shopping experience at a shopping centre over the Internet including in combination, a web server hosting a shopping centre subscription based portal website subscribed to by individual shop owners of a shopping centre, the portal website providing access to the websites of the subscribing shop owners, the portal website contactable through a universal resource locator by users, typically customers or shoppers, via a user system; the web server processor interfacing with a directory component adapted to enable location of a particular shopping centre, shop name, floor level of the shopping centre or type of goods or services, product, trade mark or by use of other key words; a navigation component adapted to display an ambulatory walk-through of the shopping centre, shop or floor level; a transactional component adapted to enable purchases to be made online, through a central merchant facility or directly from a particular merchant; an information component adapted to provide shoppers with advertising information and general information about the shopping centre; and a database for the storage and retrieval of data and information necessary for the operation of the transactional component and the information component wherein in operation the shopper can, on logging on the website and following instructions provided, experience shopping at the shopping centre by being able to navigate through the shopping centre and make purchases as if physically present in the shopping centre.

2. A system for enabling a shopping experience at a shopping centre over the Internet as claimed in claim 1, wherein the user system is a computer system with interactive display means for communication via the Internet.

3. A system for enabling a shopping experience at a shopping centre over the Internet as claimed in claim 2, wherein the interactive display means includes a visual display unit with an interactive device, typically a keypad, touch pad, mouse and/or joystick device.

4. A system for enabling a shopping experience at a shopping centre over the Internet as claimed in any one of the above claims, wherein the directory component enables shopping centres or merchants subscribing to the portal website to be located by their title, name, physical address, locality or postcode designation.

5. A system for enabling a shopping experience at a shopping centre over the Internet as claimed in any one of the above claims, wherein the navigation component provides a display of a walk-through from the shopping centre car parks, lifts, escalators, walkways and other public utilities present in a shopping centre wherein the shopper is provided with an ambulatory shopping experience simulating a physical presence at the shopping centre.

6. A system for enabling a shopping experience at a shopping centre over the Internet as claimed in any one of the above claims, wherein the transactional services component includes an online bidding component adapted to enable the shopper to submit bids for goods or services to one or more selected merchants or to merchants at large and for the merchant or merchants to accept or reject the bid online.

7. A system for enabling a shopping experience at a shopping centre over the Internet as claimed in any one of the above claims, wherein the bidding component includes an interactive facility wherein real time negotiations can be conducted between the shopper and the merchant or merchants.

8. A system for enabling a shopping experience at a shopping centre over the Internet as claimed in any one of the above claims, wherein the information component provides short video clippage of merchants discussing their goods and/or services and can provide real time online communication between the shopper and the merchant.

9. A system for enabling a shopping experience at a shopping centre over the Internet as claimed in any one of the above claims, wherein the service provider provides a delivery service of goods purchased through the system.

10. A method of shopping utilizing the system for enabling a shopping experience at a shopping centre over the Internet substantially as herein described and claimed including the steps of:
a) logging on to the subscription based portal website via the user system;
b) by following displayed instructions, selecting via the directory component, a shopping centre, shop name, type of goods or services or other key word;
c) navigating via the navigation component through the particular shopping centre selected by the simulated ambulatory walk through to a particular shop; and
d) ordering or purchasing goods or services facilitated via the transactional component.

11. A method of shopping utilizing the system for enabling a shopping experience at a shopping centre over the Internet substantially as herein described with reference to the accompanying diagrams.

12. A system for enabling a shopping experience at a shopping centre over the Internet substantially as herein described with reference to the accompanying diagrams.
